(19) United States
(12) Patent Application Publication
(10) Pub. No.: US 2011/0114196 A1
(43) Pub. Date: May 19, 2011

(54) Electronic pressure regulator

(76) Inventors: Jason Lall, Guelph (CA); Jakub Hurnik, Guelph (CA); Andrew Lakerdas, London (CA)

(21) Appl. No.: 12/802,860

(22) Filed: Jun. 15, 2010

Related U.S. Application Data
(60) Provisional application No. 61/187,893, filed on Jun. 17, 2009.

(51) Int. Cl. F15B 5/00; F16K 31/02

(52) U.S. Cl. 137/82; 251/129.15

(57) ABSTRACT

A pressure regulator includes a valve, mechanical advantage device, actuator, controller and pressure sensor. The valve is disposed between an inlet port and an outlet port. The valve includes a pintle and seat. An actuator is provided to move the pintle away from the seat to allow the flow of gas from the inlet port to the outlet port and a pintle return spring is provided to bias the pintle towards seat. The actuator is configured to move the pintle in response to the magnitude of a control signal. A control system is provided to receive a gas pressure signal from a pressure transducer at the outlet port which detects the gas pressure at the outlet port and generate a control signal having a magnitude proportional to the detected gas pressure.

### BACKGROUND OF THE INVENTION

1. Field of the Invention

This invention relates to the pressure regulator art and more particularly to an electronic gas pressure regulator.

2. Description of the Prior Art

Many stationary and mobile internal combustion engines (ICE) utilize a compressed gas such as a compressed natural gas (CNG) as a fuel which, when mixed with air, provides the energy to power the engine. The CNG is generally stored in a tank under high pressure which pressure may be, for example, on the order of 3750 pounds per square inch or about 250 bar. Such high pressure is not generally compatible with the operation of an internal combustion engine. Accordingly, the gas pressure must be reduced to a level acceptable for introduction into the ICE. The pressure level of the CNG for introduction into the ICE may be in the range of 30 pounds per square inch or 2 bar to 150 pounds per square inch or 10 bar. A pressure regulator is is installed between the tank of CNG and the ICE to provide the desired reduction in pressure of the CNG. In such pressure regulators, the CNG is introduced into an inlet port of the pressure regulator and by use of various techniques, the pressure of the gas is reduced so that at an outlet port of the pressure regulator the gas pressure is at the desired level for introduction into the ICE.

Many pressure regulator applications have heretofore utilized a mechanical pressure regulator to provide the reduction in gas pressure by utilization of a combination of valves, diaphragms and/or pistons, springs and other mechanical devices to provide the reduction in the gas pressure. The mechanical gas pressure regulators have not always been satisfactory in operation. For example, the mechanical gas pressure regulators generally could only provide an outlet, reduced gas pressure at a single pre set value that was not adjustable, thus limiting the applications in which the particular gas pressure regulator could be utilized. Additionally, in such prior mechanical gas pressure regulators, it has been found that the gas pressure tends to become lower than the set value at high gas flow rates, the diaphragms or pistons were subject to wear and tended to leak over extended operational times, and there was a “drift” or change in the pre set reduced gas pressure.

Certain version of an electronic gas pressure regulator that have heretofore been proposed. In such prior electronic gas pressure regulators, there was generally provided a two stage design. The first stage of the prior electronic pressure regulators was a mechanical pressure regulator which tended to be similar to the mechanical pressure regulators described above. The first stage reduced the gas pressure to an intermediate pressure value that was lower than the gas pressure of the CNG in the tank but higher than the desired outlet gas pressure. The gas at the intermediate pressure was introduced into a second stage where the pressure was reduced to the desired set point value for introduction into the ICE. The two stage design was desired since the force that could be provided by a typical solenoid or electrically powered actuator was insufficient to provide the movement of the structure for the control of various portions of the structure at the high input gas pressure bur would provide a satisfactory force for the movement at the intermediate gas pressure. However, such two stage gas pressure regulator often introduce structural complications and increased the cost of the pressure regulator and required rather complex designs.

Thus, there has long been a need for a single stage electronic gas pressure regulator that receives the gas such as CNG at the CNG tank storage pressure and provides an output gas pressure at any desired preset value in a range of preset values and in which the output gas pressure would be electronically maintained at the preset gas pressure value over extended operational times.

### SUMMARY OF THE INVENTION

It is an object of the present invention to provide an improved gas pressure regulator for reducing the pressure of a gas from a high value to a lower value.

It is another object of the present invention to provide an electronic gas pressure regulator for reducing the pressure of a gas from a high value of the gas in storage tank to a lower value for use by an ICE.

It is another object of the present invention to provide an improved gas pressure regulator for reducing the pressure of a CNG gas from a high value existing in a CNG storage tank to a lower value desired for operation of an ICE and maintaining the lowered gas pressure at a more precise value over a wide range of ICE operating conditions.

It is yet another object of the present invention to provide an improved gas pressure regulator for reducing the pressure of a gas from a high value to a lower value and in which the lower gas pressure value may be set to a preselected value and the preselected value may be varied over a desired range of pressures.

It is still a further object of the present invention to provide an improved single stage electronically controlled gas pressure regulator that has fewer mechanical parts, is easier and less costly to fabricate and has a comparatively long operational life.

The above and other objects of the present invention are achieved, in a first preferred embodiment thereof by providing a valve body having an inlet port and an outlet port. CNG is introduced into the inlet port at the gas pressure of the CNG in the CNG storage tank. A pintle valve chamber is provided in a plug mounted in the valve body adjacent the inlet port and a pintle valve is slidably mounted in the pintle valve chamber for reciprocal, linear translational movement in a first direction and a second direction opposite the first direction The pintle valve has an upper stem portion projecting into the pintle valve cavity and a pintle valve seal portion at a sealing end of the upper stem portion.

A pintle valve return spring surrounds the upper stem portion of the pintle valve and operatively engages the pintle valve and the valve body to bias the pintle valve in the first direction towards a closed position to provide the valve seal portion of the pintle valve against a valve seat and the pintle valve is movable against the force of the pintle valve return spring in a second direction opposite the first direction to open positions where the pintle valve is moved away from the valve seat. The amount of movement of the pintle valve away from the valve seat determines the amount of CNG that flows from the inlet port through the pressure regulator. The high pressure CNG flows from the inlet port to the pintle valve chamber. For the condition of the pintle valve in the closed position against the valve seat no CNG flows from the pintle valve chamber. As the pintle valve is moved to the open positions, the high pressure CNG flows from the pintle valve chamber past the valve seat and expands into the outlet port. The expansion of the CNG lowers the pressure of the CNG so that the gas pressure in the outlet port is at a predetermined value lower than the gas pressure at the inlet port.

The predetermined value of the gas pressure in the outlet port depends upon the flow rate of the gas through the pressure regulator and the amount that the pintle valve is moved from the seat determines the flow rate of the gas and thus the gas pressure. The flow rate of the gas is dependent upon the operating condition of an ICE to which the pressure regulator is operatively connected.

The pintle valve has a lower stem portion that extends through the valve seat and the lower stem portion is operatively connected to a pintle valve lifter so that movement of the pintle valve lifter in the second direction against the tension of the pintle valve spring moves the pintle valve away from the valve seat. An actuator lever is pivotally mounted on the valve body by a pivot pin and has a first end spaced a first preselected distance from the pivot pin. The first end operatively engages the pintle valve lifter to move the pintle valve lifter and the pintle valve in the second direction. The actuator lever also has a second end spaced from the pivot pin a second preselected distance greater than the first preselected distance, and on the opposite side from the pivot pin. If desired, a rotating ball may be placed between the pintle valve lifter and the first end of the lever to insure smooth operation in movement of the pintle valve lifter. The actuator lever is pivotally moveable about the pivot pin.

An electrically powered linear solenoid actuator is mounted on the regulator body and the operating arm of the solenoid is operatively connected to the second end of the actuator. In preferred embodiments of the present invention, a clevis may be provided which is operatively connected to the operating arm of the solenoid and the second end of the actuator lever Movement of the actuator arm of the solenoid actuator in the first direction opposite the second direction moves the pintle valve lifter and the pintle in the second direction to move the pintle valve away from the valve seat and allow the flow of gas into the outlet port. Because the first end of the actuator lever is spaced a smaller distance from the pivot than the second end of the actuator arm comparatively large movements of the second end of the actuator lever result in comparatively small movements of the first end of the actuator lever and, consequently, the force applied by the first end of the actuator lever to the pintle valve lifter is much greater than the force applied by the linear solenoid actuator to the second end of the actuator lever.

The movement of the pintle valve away from the valve seat to the maximum open position thereof maybe on the order of about 0.020 inches. The actuator arm of the linear solenoid actuator may travel a distance of 0.20 inches. Consequently there is a resulting force multiplier of about 10 to 1 to provide 10 times the force exerted by the first end of the actuator lever on the pintle valve lifter than is applied by the actuator arm of the linear solenoid actuator on the second end of the actuator lever.

In preferred embodiments of the present invention, the power to the solenoid is controlled in a negative feed back loop. A pressure transducer detects the outlet gas pressure at the outlet port of the regulator and generates a first control signal that is proportional to the magnitude of the detected pressure and may also be modified by the vehicle ECU or any pre programmed parameters. An electronic control board is provided in the control circuitry and a microprocessor is mounted on the electronic control board. The first control signal from the pressure transducer is sent to an analogue to digital converter which, in turn, sends a second control signal the microprocessor. In some embodiments of the present invention, an ASIC may be utilized in place of the microprocessor. The microprocessor or ASIC may also receive input signals from the vehicle engine ECU and/or may have any pre-programmed parameters. The microprocessor maintains the logic for tuning the regulator to vary the gas pressure at the outlet port depending upon the magnitude of the signals received and any pre-programmed parameters. The micro-processor generates a third control signal based on the signals it receives and any pre-programmed parameters and the third control signal is sent to the linear solenoid actuator and the actuator arm thereof moves in the first direction an amount determined by the magnitude of the third control signal. When the output pressure detected by the pressure transducer is lower than the desired preselected value, the magnitude of the third control signal is increased and the movement of the actuator control in the first direction increases to move the pintle valve further from the valve seat and thereby increase the gas flow through the regulator to increase the outlet gas pressure to the desired value. Similarly, if the gas pressure detected by the pressure transducer is too high, the magnitude of the third control signal is decreased causing the actuator arm of the linear solenoid actuator to move in the first direction to decrease the gas flow rate through the regulator and thus decrease the outlet gas pressure.

In another preferred embodiment of the present invention, the linear solenoid actuator is replaced by a motor controller having a rotating output shaft and a cam is mounted on the output shaft. The cam engages one end of a slidable pintle valve. The pintle valve is biased by a return spring towards a pintle valve seat. The cam is configured to move the pintle depending upon the magnitude of the third control signal, away from the seat against the return spring force to increase the gas flow through the regulator and thereby increase the gas pressure at the outlet port or to allow the return spring force on the pintle valve move the pintle closer to the valve seat to thus decrease the gas flow through the regulator and thereby decrease the gas pressure at the outlet port. The force multiplication is achieved by the various cam diameters.

In another preferred embodiment of the present invention, similar to the first embodiment described above, a linear actuator solenoid is utilized to move a tapered slider against a stem of a sliding pintle valve which is biased by a pintle return spring to bear against the tapered slider. The third control signal is sent to the linear solenoid actuator and the magnitude of the third control signal controls the position of the tapered slider that is in engagement with the pintle valve. The larger the diameter of the tapered slider that is in contact with the pintle valve, the further the pintle valve is from the valve seat and the greater the gas flow and the higher the gas pressure at the outlet port. Conversely, the smaller the diameter of the tapered slider that is in contact with the pintle valve the closer the pintle valve moves toward the valve seat under the force of the pintle valve return spring and the lower the gas flow through the regulator and the lower the gas pressure at the outlet port.

### BRIEF DESCRIPTION OF THE DRAWING

The above and other embodiments of the present invention my be more fully understood from the following detailed description taken together with the accompanying drawing wherein similar reference characters refer to similar elements throughout and in which:

FIG. 1 illustrates a conventional prior art mechanical pressure regulator of the type heretofore utilized for lowering a gas pressure;

FIG. 2 illustrates a block diagram of the control system for a gas pressure regulator according to the principles of the present invention;

FIG. 3 illustrates a sectional perspective view of a first preferred embodiment of an electronic gas pressure regulator according to the principles of the present invention;

FIG. 4 illustrates a sectional view of another preferred embodiment of the present invention; and,

FIG. 5 illustrates a sectional view of another preferred embodiment of the present invention.

### DESCRIPTION OF THE PREFERRED EMBODIMENTS

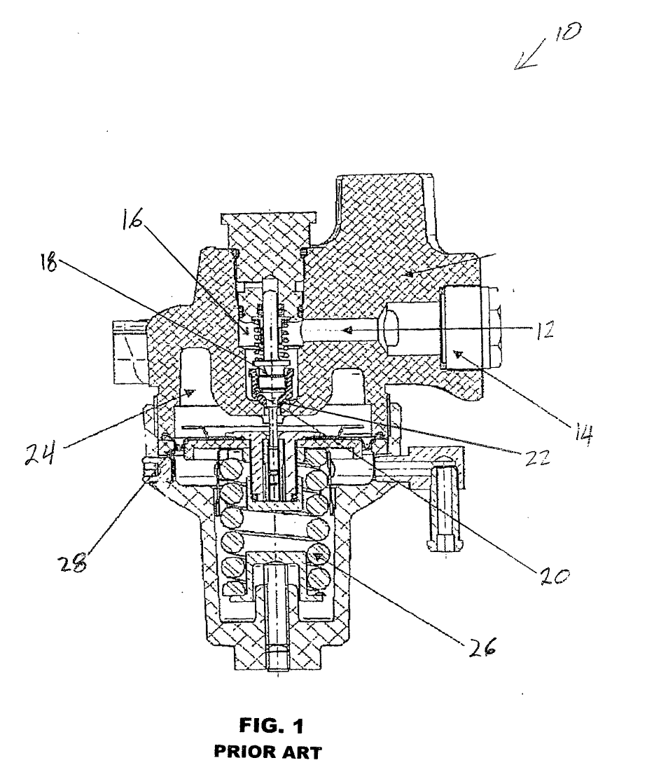

Referring now to the drawing, there is shown on FIG. 1 a prior art single stage mechanical pressure regulator 10 (of the pressure and spring balance-type mechanical regulator). High pressure gas such as CNG is stored under pressure in a tank (not shown) and the high pressure gas is introduced into a high pressure inlet port indicated at 12 which is sealed from the ambient pressure by a plug 14 and, if desired, may be filtered to remove any particulate matter in the CNG. The high pressure CNG gas enters an inlet chamber 16 and flows past a sliding pintle 18 and through an orifice 20 at the pintle seal 22 for the condition of the sliding pintle 18 free of sealing engagement with the pintle seal. The gas flows from the orifice 20 into the outlet chamber 24. A preselected desired outlet pressure for the CNG in the outlet chamber 24 is provided by pre-compressing a tower spring 26 which balances out the pressure of the CNG in the outlet chamber 24.

As the CNG flows through the regulator 10, a rise in the gas pressure of the CNG in the outlet chamber 24 acts on a diaphragm 28 and the diaphragm 28, which is operatively connected to the pintle valve 18, pushes against the force of the tower spring 26 the pintle valve will at some preselected value of outlet pressure move into the seal 22 to limit and ultimately block the flow of CNG through the orifice 20 at the pintle seal 22. When the pressure of the CNG in the in the outlet chamber 24 falls below the pre-selected value, the tower spring 26 acts to lift the pintle 18 away from a sealing condition at the orifice 20 to allow gas to flow therethrough again.

The interaction of balance between the outlet gas pressure in the outlet chamber 24 acting on the diaphragm 28 and the force exerted by the tower spring 26 regulates the outlet pressure of the CNG in the outlet chamber 24. Mechanical pressure regulators such as the single stage mechanical pressure regulator 10 shown in FIG. 1, while basically simple in construction, have the draw backs as noted above.

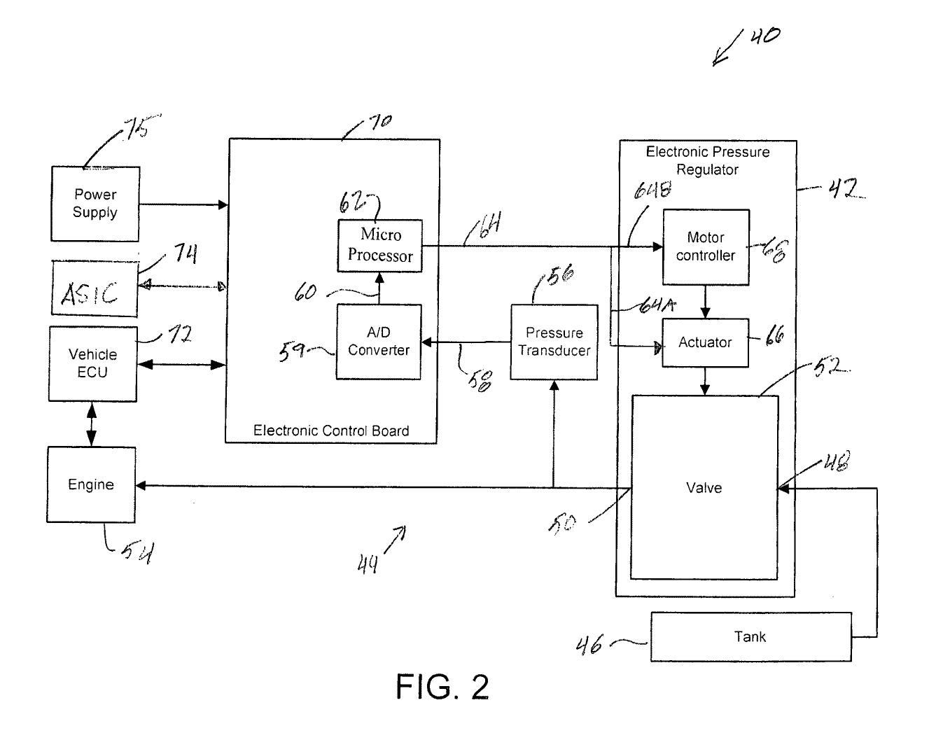

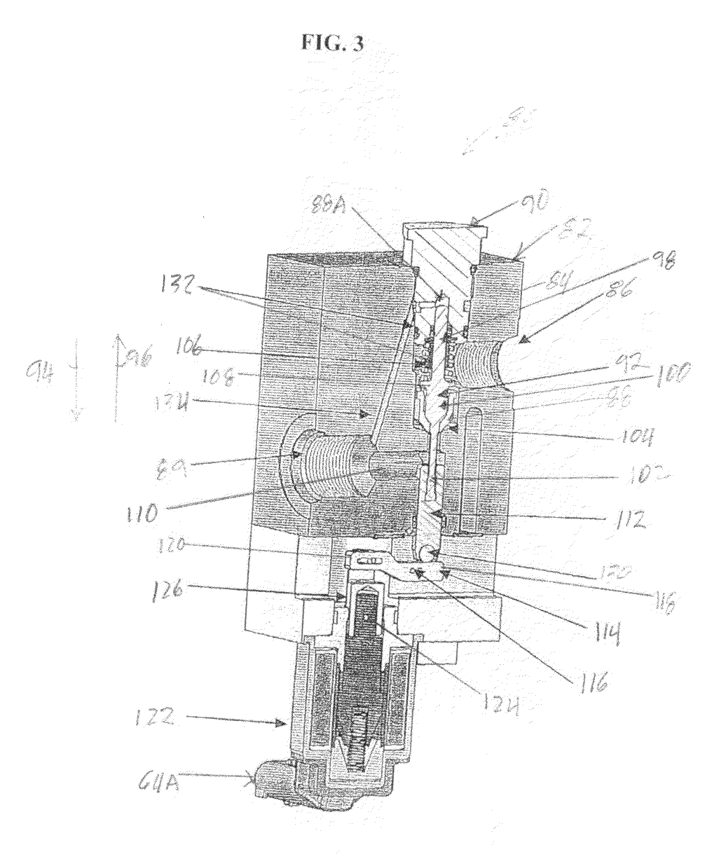

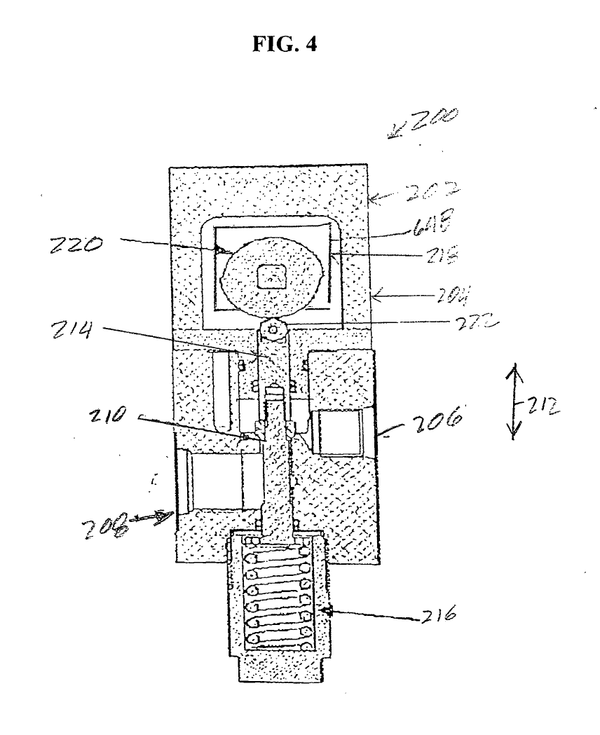

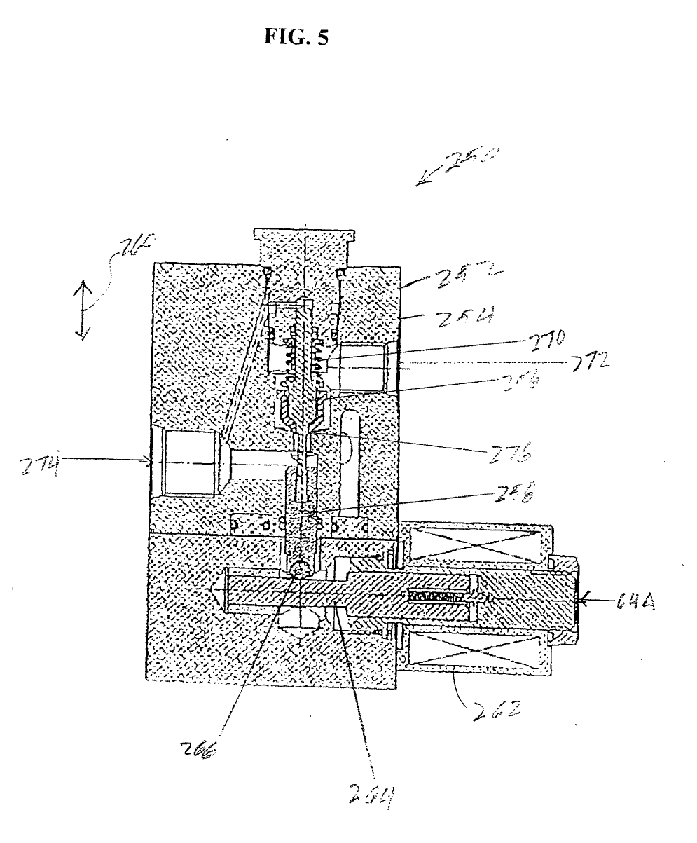

FIG. 2 illustrates a block diagram of an embodiment 40 of an electronic gas pressure regulator 42 and the control system 44 for regulating the gas pressure of, for example, CNG that is stored in a tank 46 at an elevated pressure which pressure may be on the order of 3500 pounds per square inch, or even greater. The high pressure CNG flows from the tank 46 to an inlet port indicated at 48 of the pressure regulator 42 and, as described below, as the CNG flows through the valve 52 of the pressure regulator 42 the pressure of the CNG is lowered to a value which may be in the range of 25 to 150 pounds per square inch at an outlet port indicated at 50. The lower pressure CNG flows from the outlet port to an ICE 54 wherein it is utilized as the fuel to power the ICE. A pressure transducer 56 detects the pressure of the CNG at the outlet port 50 and generates a first control signal indicated at 58 having a magnitude proportional to the detected CNG pressure and the first control signal is sent to an analogue to digital converter (A/D converter) 59. The A/D converter 59 generates a second control signal indicated at 60 having a magnitude proportional to the magnitude of the first control signal 58 and the second control signal 60 is sent to a micro processor (micro controller) 62. The micro processor or micro controller 62 generates a third control signal indicated at 64 having a magnitude proportional to the second control signal and the third control signal as indicated at 64A is sent to an actuator 66 in the embodiments shown in FIGS. 3 and 5 described below and to a motor controller 68 as indicated at 64B in the embodiment shown in FIG. 4.

If desired, additional control signals may be sent to the electronic control board 70 upon which the A/D converter 59 and the micro processor 62 are mounted so that additional information from, for example, the vehicle ECU 72 of the ICE 54 or ASIC 74 may be received by the micro processor 62 to modify the magnitude of the third control signal 64 and aid at maintaining the magnitude at a precise, pre-selected value.

A power supply 75 which may be a source of electrical power is operatively connected to the control board 70 and provides the poser for operation of the various components.

Referring now to FIG. 3, there is illustrated thereon a sectional perspective view of a first preferred embodiment generally designated 80 of an electronic gas pressure regulator 82 according to the principles of the present invention. The pressure regulator 82 has a valve body 84 which has an inlet port 86 into which a high pressure gas such as CNG is introduced the high pressure CNG is generally stored in a tank such as tank 46 of FIG. 2. The valve body 84 also has an outlet port 89 at which the CNG leaves the pressure regulator 82 at a much lower pressure, for example in the range of 30 pounds per square inch to 150 pounds per square inch. for use, for example, as a fuel for an ICE 54 as shown on FIG. 2. The ICE may be a stationary engine or a mobile engine as installed in an automobile, a truck a bus or the like. A pintle valve chamber 88 is provided in the valve body 84 and the pintle valve chamber 88 extends into a plug 90. The pintle valve chamber 88 is adjacent the inlet port 86. A pintle valve 92 is slidably mounted in the pintle valve chamber 88 for reciprocal, linear translational movement in a first direction indicated by the arrow 94 and a second direction indicated by the arrow 96 opposite the first direction. The pintle valve 92 has an upper stem portion 98, a sealing portion 100 and a lower stem portion 102.

The valve body 84 has a seal section as indicated at 104 and the seal portion 100 of the pintle valve 92 is adapted to seal against the seal section 104 for a closed condition of the seal portion 100 of the pintle valve 92 in contact therewith moved into the maximum travel in the second direction 96. The pintle valve 92 is also slidably moveable in the first direction to move the seal portion 100 of the pintle valve 92 away from the seal section 104 to provide a gas flow passage therebetween for the pintle valve in a second or open condition.

A pintle valve return spring 106 surrounds the upper stem portion 98 of the pintle valve 92 and bears against a flange 108 on the seal portion 100 of the pintle valve 92 and against the plug 90 to bias the pintle valve 92 in the first direction 94 towards the closed condition thereof. The pintle valve 92 is movable against the force of the return spring 96 to open positions. High pressure CNG is introduced into the inlet port 86 and for the condition of the pintle valve in an open condition, the high pressure CNG flows into the pintle valve chamber and past the seal section 104 and along the lower stem portion to a flow passage 110 which provides a gas flow communication between the pintle valve chamber 88 and the outlet port 89. The lower stem portion 102 is connected to a valve lifter 112 and the pintle valve 92 moves in the first direction 94 and the second direction 96 therewith.

An actuator lever 114 is pivotally mounted on the valve body 84 in regions adjacent the valve lifter and the actuator lever has a first end 118 bearing against the valve lifter 112. The first end 118 of the actuator lever 114 is spaced a first preselected distance from the pivot pin 116. The actuator lever 114 has a second end 120 that is spaced a second preselected distance greater than the first distance from the pivot pin 116.

A linear solenoid actuator 122 has an operating arm member 124 and receives the third control signal 64A. The operating arm member 124 is connected by a clevis 126 to the second end 120 of the actuator lever 114. Typical movement of the actuator arm 124 may be on the order of 0.20 inches and the typical movement of the pintle valve from the full open position to the closed position may be on the order of 0.02 inches. Thus there is provided a force multiplier on the order of 10 to 1 between the movement of the second end 120 and the first end 118.

The magnitude of the control signal 64A determines how far the operating arm member 124 travels in the second direction 94 to move the pintle valve lifter 112 and the pintle valve 92 in the second direction 96 to the open positions thereof. As noted above, the spacing between the pintle valve seal portion 100 and the valve seat 104 determines the flow rate of the CNG into the outlet port 89 and thus the pressure of the CNG in the outlet port 89.

In preferred embodiments of the present invention, a rotating ball 130 may be mounted in the pintle valve lifter and the first end 118 of the actuator lever 114 bears against the ball 130 to provide a smooth movement therebetween.

Seals 132 such as “O” ring seals may be positioned between the plug 90 and the valve body 84 and also between the upper stem 98 of the pintle valve and the valve body 84. A pressure balancing passage way 134 provides communication from the outlet port 89 to the top 88A of the pintle valve chamber 88.

Referring now to FIG. 4 the is shown another preferred embodiment 200 of an electronic gas pressure regulator 202 having a valve body 204. The valve body 204 has an inlet port 206 for receiving the high pressure CNG and an outlet port 208 where the CNG at the desired lower pressure is discharged from the valve body 204. A sliding pintle valve 210 is slidingly mounted in the valve body 204 for movement in the directions of the double ended arrow 212. The pintle valve 210 is operatively connected to a pintle valve lifter 214 for movement therewith in the directions of the arrow 212. A pintle valve return spring 216 operatively engages the pintle valve 210 and the valve body 204 for urging the pintle valve 210 into a sealing position blocking the flow of CNG from the inlet port 206 to the outlet port 208. A rotary device 218 which may be an electrically powered motor, rotary actuator or the like is connected to a cam 220. The cam 220 engages a ball 222 mounted on the pintle valve lifter 214 and as the cam rotates the pintle valve 214 is selectively moved into and out of sealing engage with the valve body to selectively stop and allow the flow of CNG through the regulator 202 from the inlet port to the outlet port 208. The rotary device 218 receives the third control signal 64B and rotates the cam 220 selectively in response to the magnitude of the third control signal 64B. The operation of the cam 220 acts as a force multiplier between the rotary device 218 and the valve lifter 214.

Referring now to FIG. 5 there is shown another preferred embodiment 250 of an electronic gas pressure regulator 252 according to the principles of the present invention. The embodiment 250 is similar to the embodiment 80 described above in connection with FIG. 3. A sliding pintle valve 256 is mounted in a valve body 254 and is connected to a valve lifter 258 to move therewith in the directions of the double ended arrow 260. A linear solenoid actuator 262 moves a tapered slider 264 against a ball 266 operatively engaging the valve lifter 258 to selectively move the pintle valve 256 against the force of the pintle valve return spring 270 whereby the pintle valve 256 may be moved to open positions to allow the flow of CNG from the inlet port 272 to the outlet port 274 and selectively moved into a sealing position to prevent the flow of CNG through the pressure regulator 252.

The larger the diameter of the tapered slider 256 engaging the ball 266 the greater the opening between the pintle valve 256 and the pintle valve seal 276 the greater the flow of the CNG through the regulator 252. Conversely, the smaller the diameter of the tapered slider 264 that is in engagement with the ball 266, the smaller the opening between the pintle valve 256 and the seal 276 and the smaller the flow of CNG until the final selected diameter of the tapered slider 264 provides the pintle valve 256 in sealing engagement with the seal 276 and thus terminates the flow of CNG. The tapered slider 264 acts as a force multiplier. The linear solenoid actuator receives the third control signal 64A and moves the tapered slider 264 in response to the magnitude of the third control signal 64A.

Although specific embodiments of the present invention have been described above with reference to the various Figures of the drawing, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

What is claimed is:

1. A pressure regulator comprising:
a valve body having an inlet port and an outlet port, said inlet port for receiving a high pressure gas and an outlet port for discharging gas at a pressure lower than said pressure at said inlet port;
a valve being disposed between said inlet port and said outlet port, said valve comprising a sliding pintle valve mounted for sliding movement in said valve body between open positions and a closed position, and said valve body having a pintle seal seat and said sliding pintle valve sealingly engaging said pintle seal seat for said sliding pintle valve in the closed position thereof and spaced from said pintle seal seat for said sliding pintle valve in said open positions thereof;
a pintle valve return spring engaging said sliding pintle valve and said valve body for yieldingly urging said sliding pintle valve towards said pintle seal seat;
an actuator operatively engaging said sliding pintle valve to selectively move the sliding pintle valve against the force of said pintle valve return spring to position said pintle valve in an open position thereof, said actuator comprising a mechanical advantage force device to multiply the force applied to said sliding pintle valve by said actuator;
a pressure sensor to detect gas pressure at said outlet port and generate a first control signal having a magnitude proportional to said detected gas pressure signal.
a control system for receiving said first control signal and powering said actuator in response to the magnitude thereof.

2. The arrangement defined in claim 1 wherein:
said actuator is a linear solenoid actuator.

3. The arrangement defined in claim 1 wherein:
said actuator is a rotary actuator.

4. The arrangement defined in claim 1 and further comprising:
said mechanical advantage force device further comprises an actuator lever pivotally mounted on said valve body by a pivot pin, and said actuator lever has a first end spaced a first preselected distance from said pivot pin and a second end spaced a second preselected distance from said pivot pin and said second preselected distance is greater than said first preselected distance;
a pintle valve lifter slideably mounted in said valve body for movement with said sliding pintle valve.

5. The arrangement defined in claim 4 wherein:
said first end of said actuator lever operatively engages said pintle valve lifter to move said sliding pintle valve away from said seat; and
said second end of said actuator lever is moved by said actuator.

6. The arrangement defined in claim 5 and further comprising:
a ball member rotateably mounted on said pintle valve lifter for engagement with said first end of said actuator lever.

7. The arrangement defined in claim 6 wherein:
said sliding pintle valve further comprises an upper stem portion, a lower stem portion and a sealing portion intermediate said upper stem portion and said lower stem portion; said sealing portion for sealing engagement with said seal seat of said valve body in for said sliding pintle valve in said closed position thereof.

8. The arrangement defined in claim 7 wherein:
said pintle valve return spring surrounds said upper stem portion;
and said pintle valve lifter reciprocatingly moveable in said valve body and fixedly connected to said lower stem portion

9. The arrangement defined in claim 1 and further comprising:
said mechanical advantage force device further comprises a tapered slider having a predetermined taper on an outer surface thereof, and said outer surface in contact with said sliding pintle valve;
said actuator is a linear solenoid actuator and said linear solenoid actuator connected to said tapered slider to move said tapered slider in reciprocating directions whereby said sliding pintle valve is moved away from said seal seat to an open position thereof and said return spring moves said sliding pintle for engagement with said tapered slider for moving said sliding pintle towards said seal seat.

10. The arrangement defined in claim 1 wherein:
said control system further comprises an analog to digital converter for receiving said first control signal and generating a second control signal having a magnitude proportional to said first control signal;

11. The arrangement defined in claim 10 and further comprising:
a micro processor for receiving said second control signal and generating a third control signal having a magnitude proportional to said second control signal, and said third control signal is applied to power said actuator.

12. The arrangement defined in claim 11 and further comprising:
a vehicle ECU signal sent to said micro processor for modifying the magnitude of said third control signal.

13. The arrangement defined in claim 12 and further comprising:
an ASIC signal sent to said micro processor for modifying the magnitude of said third control signal
